(19) United States
(12) Patent Application Publication
(10) Pub. No.: US 2015/0163484 A1
(43) Pub. Date: Jun. 11, 2015

(54) VARIABLE BITRATE ENCODING FOR MULTIPLE VIDEO STREAMS

(71) Applicant: Xinghai Li, North York (CA)

(72) Inventor: Xinghai Li, North York (CA)

(73) Assignee: VIXS SYSTEMS INC., Toronto (CA)

(21) Appl. No.: 14/100,373

(22) Filed: Dec. 9, 2013

(51) Int. Cl. H04N 19/146

(52) U.S. Cl. CPC H04N 19/00169

(57) ABSTRACT

A video processing device encodes a set of multiple input video streams by varying an average bit rate for each input video stream within a corresponding set of bounded average bit rates identified based on a target average bit rate (TABR). To encode each input video stream, the rate control module identifies the amount of space remaining to store the encoded video streams and, based on this information and the TABR, calculates an upper bound average bit rate (UBABR) and lower bound average bit rate (LBABR) for the selected input video stream. The rate control module varies the output bit rate for the corresponding encoded video stream according to the complexity of video information in the video stream, but constrains the output bit rate to ensure that the average output bit rate is constrained within the UBABR and LBABR.

### FIELD OF THE DISCLOSURE

The present disclosure generally relates to encoding of video signals and more particularly relates to variable bitrate encoding of video signals.

### BACKGROUND

In many electronic devices, video information is encoded to reduce the size of the information and thus reducing the resources required to communicate or store the video information. The encoded video information is typically decoded before it is displayed. To ensure reliable communication of video information between different electronic devices, standards have been promulgated for many encoding methods including the H.264 standard that is also referred to as MPEG-4, part 10 or Advanced Video Coding, (AVC). Rate control is frequently employed in video encoding or transcoding applications in an attempt to ensure that picture data being encoded meets various constraints, such as network bandwidth limitations, storage limitations, or processing bandwidth limitations, which may dynamically change. These constraints are reflected in the target bit rate for the resulting encoded video stream, and thus the goal of rate control is to maintain the bit rate of the encoded stream within a certain range of the target bit rate.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a multimedia system in accordance with at least one embodiment of the present disclosure.

FIG. 2 is a block diagram illustrating an example configuration of a rate control module and an encoder of the multimedia system of FIG. 1 in accordance with at least one embodiment of the present disclosure.

FIG. 3 is a diagram illustrating an example of rate control for multiple video streams in accordance with at least one embodiment of the present disclosure.

FIG. 4 is a flow diagram illustrating a method of rate control for encoding multiple video streams in accordance with at least one embodiment of the present disclosure.

### DETAILED DESCRIPTION

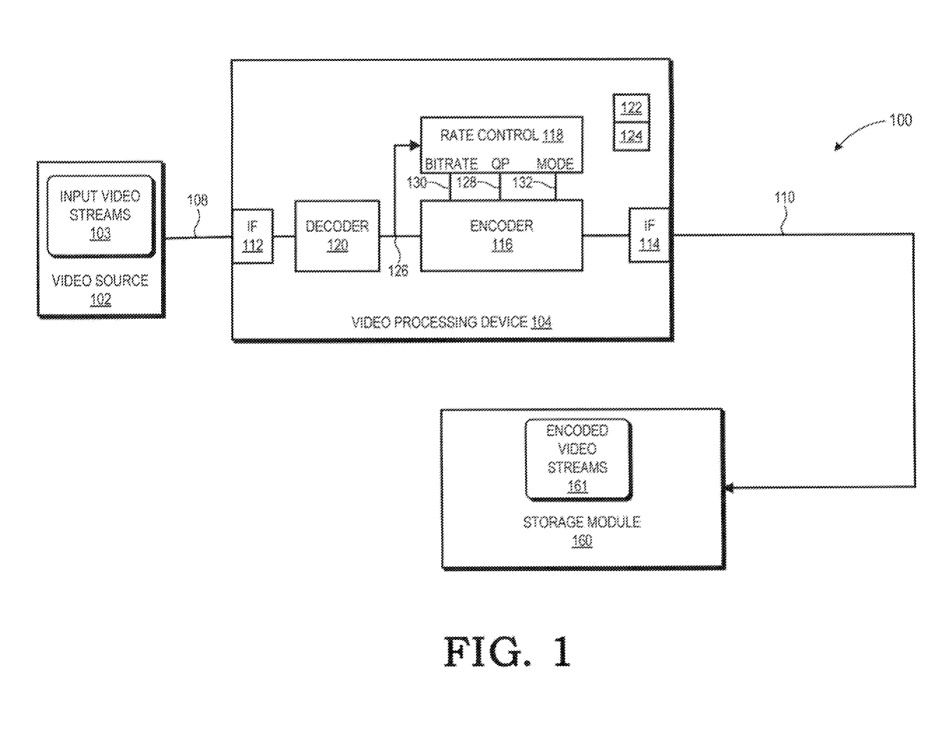

FIGS. 1-4 illustrate techniques for encoding a set of multiple input video streams by dynamically varying an output bit rate for the resulting encoded video streams by varying an average bit rate for each input video stream within a corresponding set of bounded average bit rates identified based on a target average bit rate (TABR) for the entire set of input video streams. To encode each input video stream, the rate control module identifies the amount of space remaining to store the encoded video streams and, based on this information and the TABR, calculates an upper bound average bit rate (UBABR) and lower bound average bit rate (LBABR) for the selected input video stream. The rate control module varies the output bit rate for the corresponding encoded video stream according to the complexity of video information in the video stream, but constrains the output bit rate to ensure that the average output bit rate is constrained within the UBABR and LBABR. By taking into account the amount of space remaining to store the encoded video stream, the encoder can encode complex video information in the input video streams at a higher bit rate, enhancing the quality and fidelity of the encoded video stream, relative to an encoding process where only the TABR is factored into the bit rate.

To illustrate via an example, in some scenarios an encoder may have N input video streams to encode, with each of the N input video streams having an unknown complexity relative to the other input video streams. Each of the N input streams is P seconds long, and is assigned M bytes of storage space to store the resulting encoded video streams. Conventionally, the encoder would calculate the TABR (in, e.g., megabits per second) as follows:

$$TABR = \frac{M}{N * P}$$

The encoder would then vary the output bit rate for each encoded video stream so that each encoded video stream matches the TABR. However, in many scenarios the N video streams will vary substantially in complexity, such that setting the average bit rate to the TABR for each encoded video stream causes some of the encoded video streams to have unduly limited peak bit rates, relative to their complexity, while other of the encoded video stream may have unduly high peak bit rates, relative to their complexity. In at least one embodiment, to account for these potential variations in complexity, an encoder can calculate, for each input video stream, an amount of space remaining to store the set of output encoded video streams. Based on this information, the encoder calculates an UBABR and LBABR for the corresponding encoded video stream, wherein the LBABR is, in at least one embodiment, lower than the TABR but the UBABR is higher than the TABR. The encoder encodes the input video stream such that the corresponding output encoded video stream has an average bit rate within the bounds established by the UBABR and LBABR values, but with relatively more complex portions of the input video stream encoded at closer to the UBABR and relatively less complex portions of the input video stream encoded at closer to the LBABR. Complex portions of the input video stream are therefore encoded at a higher bit rate than they would be if the encoder were generating the output encoded video stream to match the TABR. Further, as the amount of remaining space to store the set of output encoded video streams falls, the encoder can reduce one or both of the UBABR and LBABR for the remaining input video streams to ensure that the set of output encoded video streams has a collective average bit rate that matches (or does not exceed) the TABR, thereby ensuring that the set of output encoded video streams can be safely stored at the M bytes of storage space.

For ease of illustration, the techniques of the present disclosure are described in the example context of the ITU-T H.264 encoding standards, which are also commonly referred to as the MPEG-4 Part 10 standards or the Advanced Video Coding (AVC) standards. However, the techniques of the present disclosure are not limited to this context, but instead may be implemented in any of a variety of block-based video compression techniques, examples of which include the MPEG-2 standards and the ITU-T H.263 standards.

FIG. 1 illustrates, in block diagram form, a multimedia system 100 in accordance with at least one embodiment of the present disclosure. The multimedia system 100 includes a video source 102, a video processing device 104, and a storage module 160. The multimedia system 100 can represent any of a variety of multimedia systems in which encoding or transcoding can be advantageously used. In one embodiment, the multimedia system 100 is a video system such as a digital video editing recorder, whereby the video source 102 comprises a terrestrial, cable, or satellite television broadcaster, an over-the-top (OTT) multimedia source or other Internet-based multimedia source, and the like. In this implementation, the video processing device 104 and the storage module 160 together are implemented as user equipment, such as a set-top box, a tablet computer or personal computer, a computing-enabled cellular phone, and the like. Thus, the video processing device 104 encodes or transcodes an input video stream and the resulting encoded video stream is buffered or otherwise stored at the storage module 160 for subsequent retrieval and playback. The storage module 160 can be a cache, memory, hard drive or other storage device that allows stored video to be accessed for decoding and display at a video destination (not shown) such as a television monitor.

In operation, the video source 102 transmits or otherwise provides input video streams 103, via a video input 108, to the video processing device 104 in either an analog format, such as a National Television System Committee (NTSC) or Phase Alternating Line (PAL) format, or a digital format, such as an H.263 format, an H.264 format, a Moving Picture Experts Group (MPEG) format (such as MPEG1, MPEG-2 or MPEG4), QuickTime format, Real Media format, Windows Media Video (WMV) or Audio Video Interleave (AVI), or other digital video format, either standard or proprietary. In instances whereby the input video streams 103 have an analog format, the video processing device 104 operates to encode the input video streams 103 to generate a set of encoded video streams 161, and in instances whereby the input video streams 103 have has a digital format, the video processing device 104 operates to transcode the input video stream 108 to generate the set of encoded video streams 161. The resulting set of encoded video streams 161 are provided, via an output 110, to the storage module 160 for subsequent decoding and display. In at least one embodiment, each of the input video streams 103 is individually encoded, via a one-pass encoding process, to generate a corresponding one of the set of encoded video streams 161. Further, in at least one embodiment, the set of encoded video streams 161 is assigned, by an operating system, application software, or other module, a specified portion of the storage module 160, such that the set of encoded video streams 161 can only be stored at the specified portion.

In the illustrated embodiment, the video processing device 104 includes interfaces 112 and 114, an encoder 116, a rate control module 118, and, in instances whereby the video processing device 104 provides transcoding, a decoder 120. The interfaces 112 and 114 include interfaces used to communicate signaling with the video source 102 and the video destination 106, respectively. Examples of the interfaces 112 and 114 include input/output (I/O) interfaces, such as Peripheral Component Interconnect Express (PCIE), Universal Serial Bus (USB), Serial Attached Technology Attachment (SATA), wired network interfaces such as Ethernet, or wireless network interfaces, such as IEEE 802.11x or Bluetooth™ or a wireless cellular interface, such as a 3GPP, 4G, or LTE cellular data standard. The decoder 120, the encoder 116, and rate control module 118 each may be implemented entirely in hard-coded logic (that is, hardware), as the combination of software stored in a memory 122 and a processor 124 to access and execute the software, or as combination of hard-coded logic and software-executed functionality. To illustrate, in one embodiment, the video processing device 104 is implemented as a SOC whereby portions of the decoder 120, the encoder 116, and the rate control module 118 are implemented as hardware logic, and other portions are implemented via firmware stored at the SOC and executed by a processor of the SOC.

The hardware of the video processing device 104 can be implemented using a single processing device or a plurality of processing devices. Such processing devices can include a central processing unit (CPU), a graphics processing unit (GPU), a microcontroller, a digital signal processor, a field programmable gate array, programmable logic device, state machine, logic circuitry, analog circuitry, digital circuitry, or any device that manipulates signals (analog and/or digital) based on operational instructions that are stored in a memory, such as the memory 122. The memory 122 may be a single memory device or a plurality of memory devices. Such memory devices can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

In a transcoding mode, the decoder 120 operates to receive the input video streams 103 via the interface 112 and partially or fully decode each of the input video streams 103 to create a corresponding decoded data stream 126, which can include pixel information, motion estimation/detection information, timing information, and other video parameters. The encoder 116 receives the decoded data stream 126 and uses the video parameters represented by the decoded data stream to generate a corresponding encoded video stream of the set of encoded video stream 161, which comprises a transcoded representation of the video content of the corresponding one of the input video streams 103. The transcoding process implemented by the encoder 116 can include, for example, a stream format change (e.g., conversion from an MPEG-2 format to an AVC format), a resolution change, a frame rate change, a bit rate change, and the like. In an encoding mode, the decoder 120 is bypassed and each of the input video streams 103 is digitized and then encoded by the encoder 116 to generate the corresponding one of the encoded video streams 161.

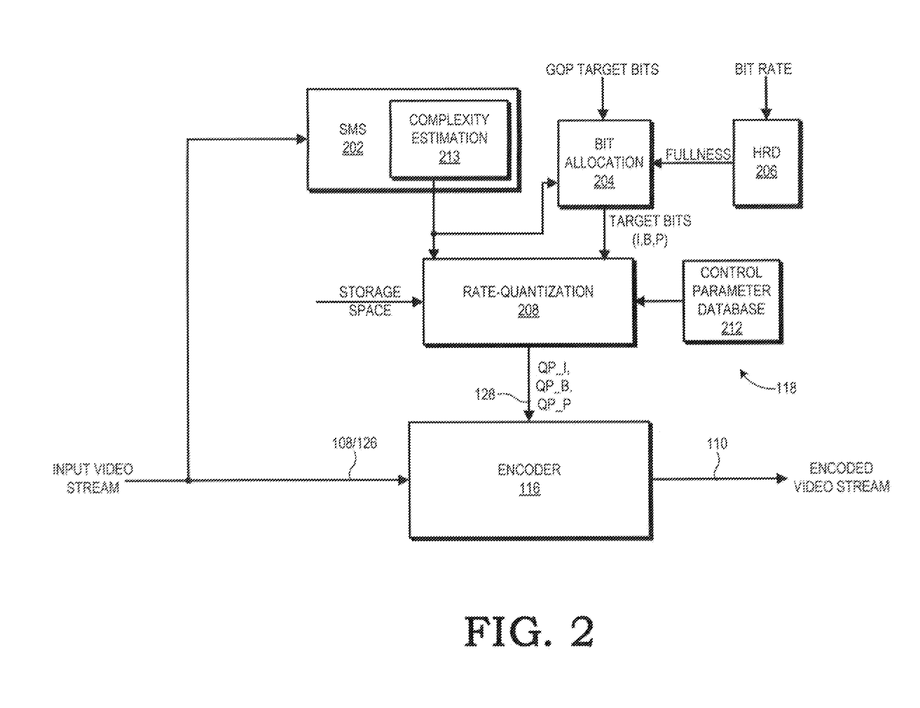

In at least one embodiment, the rate control module 118 utilizes the amount of space allotted to store the set of encoded video streams 161 to dynamically determine and adjust various encoding parameters used by the encoder 116 to encode each the input video streams 108. In one embodiment, these encoding parameters include a control signal 128 (denoted “QP” in FIG. 1) to configure one or more quantization parameters used during by quantization process of the encoder 116, a control signal 130 (denoted “BITRATE” in FIG. 2) to configure the target bit allocation for one or more picture types, as well as a control signal 132 (denoted “MODE” in FIG. 1) to select an encoding mode to be employed by the encoder 116. As described in greater detail below, the rate control module 118 continuously monitors the complexity of the pictures to be encoded and the remaining stream time to determine updated QP values and updated target bitrate allocations and signals the new QP values and target bitrate allocations via control signals 128 and 130, respectively. In at least one embodiment, the rate control module 118 identifies the QP values as follows: the rate control module 118 identifies the amount of space allotted to store the set of encoded video streams 161. Based on these parameters, the rate control module 118 identifies the TABR for the set of encoded video streams 161 as explained above.

In particular, to encode a selected one of the input video streams 103, the rate control module 118 calculates the space remaining at the storage module 160 to store the encoded video streams 161 by subtracting the space consumed by previously encoded video streams from the total space allotted. This remaining space value is designated, for purposes of description, as value SR. Based on the SR value, the rate control module 118 identifies a weight value, designated WV. In at least one embodiment, the rate control module 118 accesses a table that identifies, for each of a plurality of ranges of the SR value, a corresponding WV, wherein WV is a decimal value between zero and one. The rate control module 118 multiplies the TABR for the set of encoded video streams 161 by the WV value to calculate the LBABR for the corresponding one of the set of encoded video streams 160 to be generated. Thus, the LBABR for the one of the set of encoded video streams 160 is expressed as follows:

LBABR=WV×TABR

Further, the rate control module 118 calculates the UBABR for the one of the set of encoded video streams 160 as follows:

$$UBABR = \frac{TABR}{WV}$$

In at least one embodiment, the rate control module 118 can use different weight values to calculate each of the LBABR and UBABR values. The rate control module 118 continuously monitors the complexity of the pictures of the selected one of the input video streams 103 to be encoded to determine updated QP values and updated target bitrate allocations, to ensure that the resulting one of the encoded video streams 161 has a variable bit rate such that the average output bit rate for an encoded video stream is maintained within the LBABR and UBABR values. The rate control module 118 signals the new QP values and target bitrate allocations via control signals 128 and 130, respectively.

In at least one embodiment, the WV values are set so that, when all of the set of encoded video streams 161 are encoded, the average bit rate for the set of encoded video streams 161 substantially matches the TABR value. In at least one embodiment, the rate control module 118 identifies when the last of the input video streams 106 is ready to be encoded and, in response, sets the LBABR and UBABR values below the TABR value to ensure that the overall average bit rate of the set of encoded video streams 161 substantially matches the TABR value.

FIG. 2 illustrates an example implementation of the rate control module 118 in greater detail in accordance with at least one embodiment of the present disclosure. In the depicted example, the rate control module 118 includes a SMS module 202, a bit allocation module 204, a hypothetical reference decoder (HRD) 206, and a rate-quantization module 208.

In operation, the encoder 116 employs a subtraction process and motion estimation process for data representing macroblocks of pixel values for a picture to be encoded. The motion estimation process, employed by the SMS module 202, compares each of these new macroblocks with macroblocks in a previously stored reference picture or pictures to find the macroblock in a reference picture that most closely matches the new macroblock. The motion estimation process then calculates a motion vector, which represents the horizontal and vertical displacement from the macroblock being encoded to the matching macroblock-sized area in the reference picture. The motion estimation process also provides this matching macroblock (known as a predicted macroblock) out of the reference picture memory to the subtraction process, whereby it is subtracted, on a pixel-by-pixel basis, from the new macroblock entering the encoder. This forms an error prediction, or “residual”, that represents the difference between the predicted macroblock and the actual macroblock being encoded. The encoder 116 employs a two-dimensional (2D) discrete cosine transform (DCT) to transform the residual from the spatial domain. The resulting DCT coefficients of the residual are then quantized using a corresponding QP so as to reduce the number of bits needed to represent each coefficient. The quantized DCT coefficients then may be Huffman run/level coded to further reduces the average number of bits per coefficient. This is combined with motion vector data and other side information (including an indication of I, P or B pictures) for insertion into the encoded video stream 110.

For the case of P/B reference pictures, the quantized DCT coefficients also go to an internal loop that represents the operation of the decoder (a decoder within the encoder). The residual is inverse quantized and inverse DCT transformed. The predicted macroblock is read out of the reference picture memory is added back to the residual on a pixel by pixel basis and stored back into a memory to serve as a reference for predicting subsequent pictures. The encoding of I pictures uses the same process, except that no motion estimation occurs and the negative (−) input to the subtraction process is to be spatial predicted. In this case the quantized DCT coefficients represent residual values from spatial prediction rather than from both temporal and spatial prediction as was the case for P and B pictures. As is the case for P/B reference pictures, decoded I pictures are stored as reference pictures.

The rate quantization module 208 receives the amount of space allotted to store the set of encoded video streams 161 and, based on that information, identifies for each of the input video streams 103, the amount of space remaining to store the remaining ones of the set of encoded video streams 161. Based on the amount of space remaining and the TABR for the set of encoded video streams 161, the rate quantization module 208 identifies the LBABR and the UBABR values, as described above. The rate-quantization module 208 uses the image complexity, target bit allocations, and LBABR and UBABR values as parameters for determining the QP, which in turn determines the degree of quantization performed by the encoder 116 and thus influences the bit rate of the resulting encoded video data. In one embodiment, the image complexity is estimated by an complexity estimation module 213 (implemented, for example, as part of the SMS module 202), which calculates a SVAR metric and a PCOST metric from the residuals and other pixel information of a picture as an estimate of image complexity for a picture to be encoded. The SVAR and PCOST metrics may be calculated using any of a variety of well-known algorithms. The bit allocations are represented by target numbers of bits that may be allocated at different granularities, such as per picture, GOP, slice, or block. In one embodiment, the HRD 206 maintains a model of the buffer fullness (e.g., a coded picture buffer (CPB)) of a modeled decoder at the video destination 106 (FIG. 1) receiving the encoded video stream 110. The bit allocation module 204 identifies an average bit rate based on the complexity indicated by the SVAR and PCOST metrics, and ensures that the average bit rate is within the UBABR and LBABR values. For example, in one embodiment when the SVAR and PCOST metrics are at their maximum values, or otherwise indicate a complexity above a maximum threshold, the bit allocation module 204 can set the average bit rate at or near the UBABR value. Similarly, when the SVAR and PCOST metrics indicate a complexity below a minimum threshold, the bit allocation module 204 can set the average bit rate to be at or near the LBABR value. When the complexity is between the minimum and maximum thresholds, the bit allocation module 204 can set the average bit rate between the UBABR and LBABR values, in the same proportion as the relationship of the complexity between the minimum and maximum thresholds. The bit allocation module 204 then determines the number of target bits to allocate based on the buffer fullness, the SVAR and PCOST metrics, the remaining stream time, the group of pictures (GOP) structure to allocate bits to achieve the average bit rate, using any of a variety of well-known bit allocation algorithms.

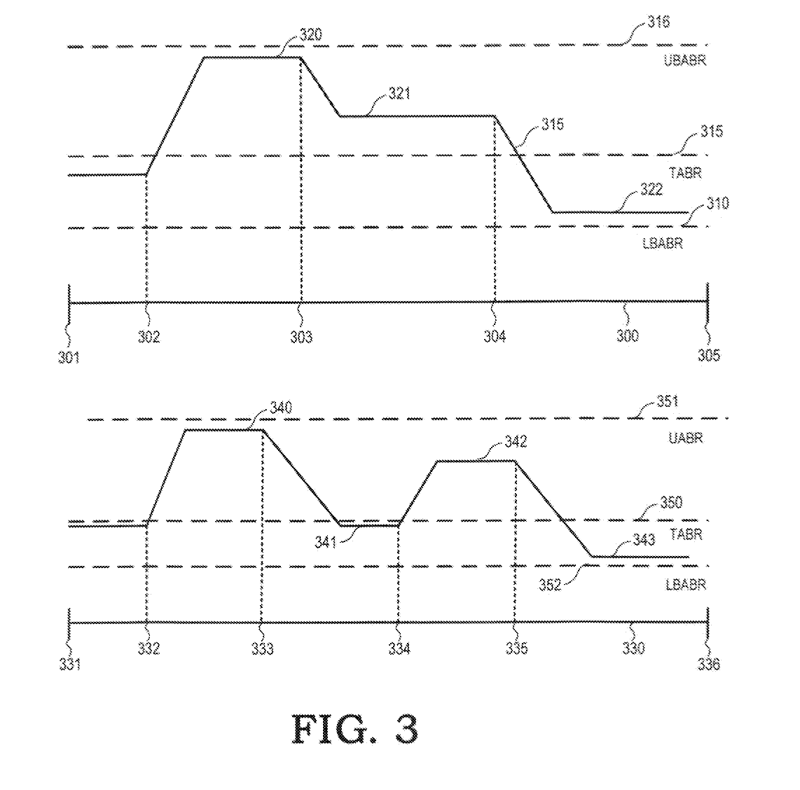

FIG. 3 illustrates an example of the rate control module 118 adjusting the average bit rate for two of the set of encoded video streams 161, designated for purposes of description “video stream A” and “video stream B” in accordance with at least one embodiment. FIG. 3 illustrates a timeline 300, representing the time used to encode video stream A, and a corresponding curve 310, illustrating the accumulated average bit rate for encoded video stream A as it varies over time based on changes to the average bit rate effectuated by the rate control module 118. Curve 315 illustrates the TABR for the entire set of encoded video streams 161, as calculated based on the space allotted for their storage at the storage module 160. Curve 316 illustrates the UBABR for video stream A and curve 317 illustrates the LBABR for video stream A, as calculated by the rate control module 118 based on the remaining space available to store the set of encoded video streams 161 and based on the TABR. In the illustrated example, the LBABR has been calculated to have a value lower than the TABR value, but the UBABR has a value higher than the TABR value. Accordingly, if video stream A is a stream with a relatively large amount of complexity, the complex portions will be encoded at a higher bit rate than if the stream were encoded using only the TABR value to generate the bit rate, improving the accuracy and fidelity of encoded video stream A.

Time 301 of the timeline 300 indicates the time where the encoder 110 initiates a one-pass encoding of the corresponding one of the input video streams 103 to be encoded, and time 305 indicates the end of the one-pass encoding. It is assumed that the input video stream is being encoded in a streaming fashion, as it is received, rather than based on the entire input video stream being stored and subsequently encoded.

Between time 301 and time 302, the rate control module 118 identifies increasing complexity of the input video stream 108 that is to be encoded. Accordingly, the rate control module 118 increases the average bit rate over time, so that the accumulated average bit rate reaches a level designated level 320 that is near, but below, the UBABR value. Level 320 is higher than the accumulated average bit rate that would be set by the rate control module 118 if it were encoding video stream A based only on the TABR value. Between time 302 and time 303, the rate control module 118 identifies that the input video stream has a reduced, but still relatively high complexity. In response, the rate control module 118 lowers the accumulated average bit rate for encoded video stream A to a lower level, designated level 321. Between time 303 and time 304, the rate control module 118 identifies that the complexity of the input video stream has fallen, and in response sets the accumulated average bit rate for the encoded video stream 110 to a lower level, designated level 322.

FIG. 3 also illustrates a timeline 330, representing the time used to encode video stream B, and a corresponding curve 349, illustrating the accumulated average bit rate for encoded video stream B as it is varied over time by the rate control module 118. Curve 350 illustrates the TABR for the entire set of encoded video streams 161, as calculated based on the space allotted for their storage at the storage module 160. Curve 351 illustrates the UBABR for video stream B and curve 352 illustrates the LBABR for video stream B, as calculated by the rate control module 118 based on the remaining space available to store the set of encoded video streams 161 and based on the TABR. In the illustrated example, the LBABR has been calculated to have a value lower than the TABR value, but the UBABR has been calculated to have a value higher than the rate control module 118 would use to generate video stream B if it encoded the stream based only on the TABR value. In addition, because encoded video stream A has already been encoded and stored at the storage module 160, there is less available space to store encoded video stream B. Therefore, the UBABR and LBABR values for video stream B are smaller than the UBABR and LBABR values, respectively, for video stream A.

Time 331 of the timeline 330 indicates the time where the encoder 110 initiates a one-pass encoding of the corresponding one of the input video streams 103 to be encoded, and time 336 indicates the end of the one-pass encoding. It is assumed that the input video stream 108 is being encoded in a streaming fashion, as it is received.

Between time 331 and time 332, the rate control module 118 identifies a relatively complex portion of the input video stream is to be encoded. Accordingly, the rate control module 118 changes the bit rate for the encoded video stream 110 over time so that the accumulated average bit rate reaches a level, designated level 340 that is at or near, but below, the UBABR value. Level 320 is higher than the accumulated bit rate that would be result if video stream B were encoded based only on the TABR value. Between time 333 and time 334, the rate control module 118 identifies that the input video stream has a reduced complexity. In response, the rate control module 118 changes the bit rate for encoded video stream B so that the accumulated average bit rate falls to a lower level, designated level 341, that is near the LBABR value. Between time 333 and time 334, the rate control module 118 identifies that the complexity of the input video stream 108 has increased, and in response changes the bit rate for the encoded video stream B so that the accumulated average bit rate for the stream rises to a higher level, designated level 342. Between time 334 and time 335, the rate control module 118 identifies that the complexity of the input video stream has fallen, and in response changes the bit rate for the encoded video stream 110 so that the accumulated average bit rate falls to a lower level, designated level 343.

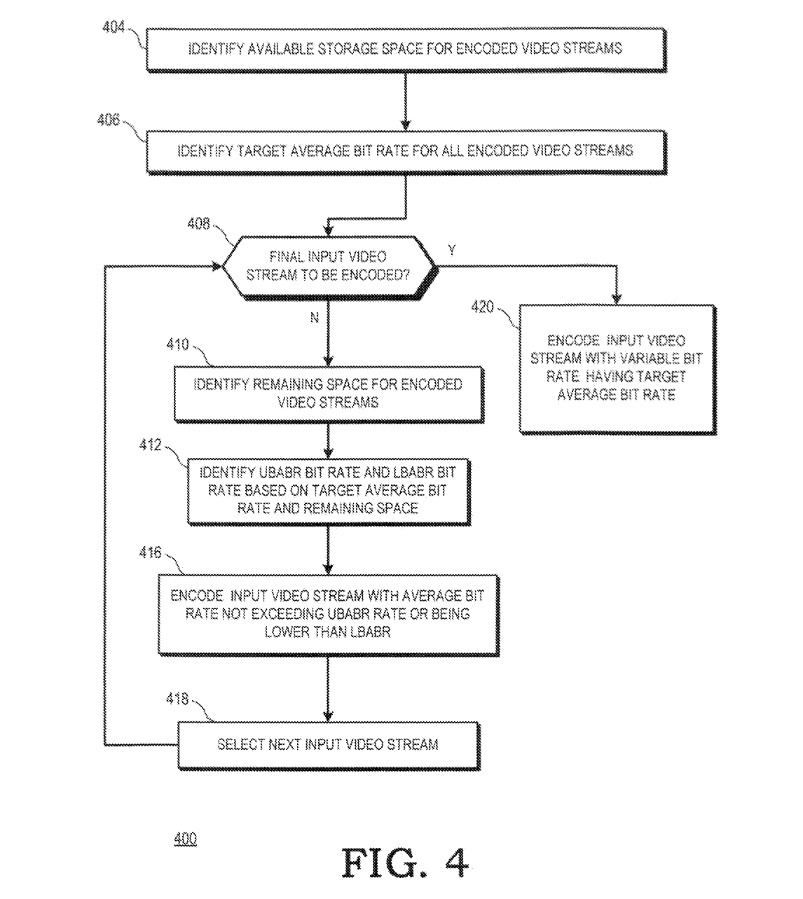

FIG. 4 illustrates a flow diagram of a method 400 of setting average bit rates for bit rate for encoding each of a plurality of input video streams based on the amount of space available to store the resulting encoded video streams in accordance with at least one embodiment. For purposes of description, the method is described with respect to an example implementation at the video processing device 104 of FIG. 1. At block 404 the video processing device 104 identifies the amount of storage space at the storage module 160 allotted to store the set of encoded video streams 161. At block 406 the decoder identifies, based on amount of space allotted to store the set of encoded video streams 161, the target average bit rate for the encoded video streams 161. In at least one embodiment, this is the average bit rate that will allow all of the set of encoded video streams 161 to be stored in the space allotted. The video processing device 104 selects the first input video stream of the input video streams 110 for encoding.

At block 408, the video processing device 104 identifies whether the last of the input video streams 103 has been selected for encoding. If not, the method flow moves to block 410 and the rate control module 118 identifies the unused space remaining of the space allotted to store the set of encoded video streams 161. At block 412 the rate control module 118 calculates the UBABR and LBABR values for the selected input video stream based on the TABR for the set of encoded video streams 161 and the amount of space remaining that was identified at block 408. At block 416 the video processing device 104 encodes the selected input video stream at a variable bit rate, wherein the bit rate is varied according to the complexity of the selected input video stream, but is constrained to meet an average bit rate selected based on the complexity of the selected input video stream. In addition, the average bit rate is selected so that is maintained between the LBABR and UBABR values. The video processing device 104 stores the encoded video stream at the storage module 160, thereby reducing the amount of space available to store additional ones of the set of encoded video streams 161. At block 418 the video processing device 104 selects the next input stream of the input streams 103 for encoding. The method flow returns to block 408 for the encoding of the selected input video stream.

Returning to block 408, if the video processing device 104 identifies that the input video stream selected for encoding is the last input stream to be encoded, the method flow moves to block 420 and the video processing device 104 encodes the last input video stream with a variable bit rate using the TABR value. This ensures that the set of encoded video streams 110 can be stored in the space allotted at the storage module 160.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
identifying a first average bit rate for encoding input video streams based on a first amount of storage space to store a plurality of encoded video streams;
identifying a second average bit rate and a third average bit rate based on the first average bit rate, the second average bit rate different from the third average bit rate; and
encoding a first input video stream of the input video streams at a fourth average bit rate between the second average bit rate and the third average bit rate.

2. The method of claim 1, further comprising:
identifying a fifth average bit rate and a sixth average bit rate based on a second amount of storage space; and
encoding a second input video stream of the input video streams at a seventh average bit rate between the fifth average bit rate and the sixth average bit rate.

3. The method of claim 2, wherein the second average bit rate is different from the fifth average bit rate.

4. The method of claim 2, wherein the third average bit rate is different than the sixth average bit rate.

5. The method of claim 2, further comprising:
selecting the fourth average bit rate and the seventh average bit rate so that an average bit rate for the plurality of encoded video streams matches the first average bit rate.

6. The method of claim 2, wherein encoding the first input video stream comprises encoding the first input video stream to generate a first encoded video stream of the plurality of encoded video streams, and further comprising:
identifying the second amount of storage space based on an amount of storage space used to store the first encoded video stream.

7. The method of claim 6, further comprising:
selecting the fifth average bit rate based on the second amount of storage space.

8. The method of claim 2, further comprising:
encoding a third input video stream of the input video streams at the first average bit rate.

9. The method of claim 8, wherein encoding the third input video stream at the first average bit rate comprises:
encoding the third input video stream at the first average bit rate in response to identifying the third input video stream as a final input video stream of the input video streams to be encoded.

10. A method, comprising:
identifying a first amount of storage space to store a plurality of encoded video streams based on a corresponding plurality of input video streams;
identifying a first average bit rate based on the amount of storage space;
identifying a second average bit rate and a third average bit rate based on the first average bit rate, the second average bit rate different than the first average bit rate and the third average bit rate; and
encoding a first input video stream of the plurality of input video streams at fourth average bit rate selected to be between the second average bit rate and the third average bit rate to generate a first encoded video stream of the plurality of encoded video streams.

11. The method of claim 10, further comprising:
identifying a fifth average bit rate and a sixth average bit rate based on the first average bit rate and an amount of storage space to store the first encoded video stream; and
encoding a second input video stream of the plurality of input video streams at a seventh average bit rate selected to be between the fifth average bit rate and the sixth average bit rate to generate a second encoded video stream of the plurality of encoded video streams.

12. The method of claim 1, further comprising:
encoding a third input video stream of the plurality of input video streams at a variable bit rate based on the first average bit rate to generate a third encoded video stream of the plurality of encoded video streams.

13. A video processing device comprising:
an interface to receive a plurality of input video streams; and
an encoder to:
identify a first average bit rate for encoding input video streams based on a first amount of storage space to store a plurality of encoded video streams;
identify a second average bit rate and a third average bit rate based on the first average bit rate, the second average bit rate different from the third average bit rate; and
encode a first input video stream of the input video streams at a fourth average bit rate between the second average bit rate and the third average bit rate.

14. The video processing device of claim 13, wherein the encoder is to:
identify a fifth average bit rate and a sixth average bit rate based on a second amount of storage space; and
encoding a second input video stream of the input video streams at a seventh average bit rate between the fifth average bit rate and the sixth average bit rate.

15. The video processing device of claim 14, wherein the second average bit rate is different from the fifth average bit rate.

16. The video processing device of claim 14, wherein the third average bit rate is different than the sixth average bit rate.

17. The video processing device of claim 14, wherein the encoder is to:
select the fourth average bit rate and the seventh average bit rate so that an average bit rate for the plurality of encoded video streams matches the first average bit rate.

18. The video processing device of claim 14, wherein the encoder is to encode the first input video stream comprises to generate a first encoded video stream of the plurality of encoded video streams, and the encoder is further to:
identify the second amount of storage space based on an amount of storage space used to store the first encoded video stream.

19. The video processing device of claim 18, wherein the encoder is to:
select the fifth average bit rate based on the second amount of storage space.

20. The video processing device of claim 14, wherein the encoder is to:
encode a third input video stream of the input video streams at the first average bit rate.
